(19) United States
(12) Patent Application Publication
(10) Pub. No.: US 2026/0278251 A1
(43) Pub. Date: Sep. 17, 2026

(54) INTERACTION METHOD, APPARATUS, STORAGE MEDIUM AND PROGRAM PRODUCT

(71) Applicant: Beijing Zitiao Network Technology Co., Ltd., Beijing (CN)

(72) Inventors: Dandan SHEN, Beijing (CN); Xiang Jiang, Beijing (CN)

(21) Appl. No.: 19/542,631

(22) Filed: Feb. 17, 2026

(30) Foreign Application Priority Data
Mar. 13, 2025 (CN) 202510300021.3

(51) Int. Cl. G06F 40/166; G06F 3/0482; G06T 11/60

(52) U.S. Cl. CPC G06F 40/166; G06F 3/0482; G06T 11/60

(57) ABSTRACT

The present disclosure relates to the field of computer technologies, and provides an interaction method, an apparatus, a storage medium and a program product. The interaction method includes: generating first content, in response to an instruction for generating the first content input in a conversation area; displaying an editing area matching a genre of the first content and displaying the first content in the editing area, the editing area and the conversation area being presented on a same interface; determining an editing command for the first content based on the first content and the genre of the first content, in response to an editing operation triggered in the conversation area or the editing area; and editing the first content in the editing area based on the editing command.

### CROSS-REFERENCE TO RELATED APPLICATIONS

The present application is based on and claims priority to Chinese Application No. 202510300021.3, filed on Mar. 13, 2025, which is incorporated herein by reference in its entirety.

### TECHNICAL FIELD

The present disclosure relates to the field of computer technologies, and in particular, to an interaction method and apparatus, a storage medium, and a program product.

### BACKGROUND

With the development of artificial intelligence technologies, users may have a conversation with an agent to obtain information efficiently, and users may also use the agent to create content.

### SUMMARY

According to some embodiments of the present disclosure, an interaction method is provided, including: generating first content, in response to an instruction for generating the first content input in a conversation area; displaying an editing area matching a genre of the first content and displaying the first content in the editing area, the editing area and the conversation area being presented on a same interface; determining an editing command for the first content based on the first content and the genre of the first content, in response to an editing operation triggered in the conversation area or the editing area; and editing the first content in the editing area based on the editing command.

According to some other embodiments of the present disclosure, an interaction apparatus is provided, including: a generation module configured to generate first content, in response to an instruction for generating the first content input in a conversation area; a display module configured to display an editing area matching a genre of the first content and displaying the first content in the editing area, the editing area and the conversation area being presented on a same interface; a determination module configured to determine an editing command for the first content based on the first content and the genre of the first content, in response to an editing operation triggered in the conversation area or the editing area; and an editing module configured to edit the first content in the editing area based on the editing command.

According to some embodiments of the present disclosure, an interaction apparatus is provided, including: a memory; and a processor coupled to the memory, wherein the processor is configured to, based on instructions stored in the memory, implement the interaction method of any one of the embodiments described in the present disclosure.

According to some embodiments of the present disclosure, a non-transitory computer-readable storage medium is provided, having computer instructions stored thereon, where the interaction method of any one of the embodiments described in the present disclosure is implemented when the instructions are executed by a processor.

According to some embodiments of the present disclosure, a computer program product is provided, including: computer instructions, where the interaction method of any one of the embodiments described in the present disclosure is implemented when the computer instructions are executed by a processor.

Other features, aspects and advantages of the present disclosure will become apparent through the following detailed description of exemplary embodiments of the present disclosure with reference to the drawings.

### BRIEF DESCRIPTION OF THE DRAWINGS

Reference is made to the drawings to illustrate the embodiments of the present disclosure. It should be understood that the drawings in the following description relate only to some embodiments of the present disclosure, rather than limiting the present disclosure. In the drawings:

FIG. 1 is a schematic flowchart of an interaction method according to some embodiments of the present disclosure;

FIG. 2 is a schematic flowchart of determining an editing command for first content according to some embodiments of the present disclosure;

FIG. 3A is a schematic diagram of an interface related to a writing genre according to some embodiments of the present disclosure;

FIG. 3B is a schematic diagram of an interface related to a writing genre according to some other embodiments of the present disclosure;

FIG. 3C is a schematic diagram of an interface related to an image genre according to some embodiments of the present disclosure;

FIG. 3D is a schematic diagram of an interface related to an image genre according to some other embodiments of the present disclosure;

FIG. 3E is a schematic diagram of an interface related to a programming genre according to some embodiments of the present disclosure;

FIG. 3F is a schematic diagram of an interface related to a programming genre according to some other embodiments of the present disclosure;

FIG. 4A is a schematic diagram of an interface related to a writing genre according to some further embodiments of the present disclosure;

FIG. 4B is a schematic diagram of an interface related to a writing genre according to some other embodiments of the present disclosure;

FIG. 4C is a schematic diagram of an interface related to an image genre according to some further embodiments of the present disclosure;

FIG. 4D is a schematic diagram of an interface related to an image genre according to some further embodiments of the present disclosure;

FIG. 5 is a schematic flowchart of determining an editing command for first content according to some other embodiments of the present disclosure;

FIG. 6A is a schematic diagram of an interface related to a writing genre according to some still other embodiments of the present disclosure;

FIG. 6B is a schematic diagram of an interface related to an image genre according to some still other embodiments of the present disclosure;

FIG. 7 is a schematic flowchart of determining an editing command for first content according to some still other embodiments of the present disclosure;

FIG. 8 is a schematic diagram of an interface related to a writing genre according to some still other embodiments of the present disclosure;

FIG. 9 is a schematic flowchart of determining an editing command for first content according to some still other embodiments of the present disclosure;

FIG. 10A is a schematic diagram of actively providing content suggestions according to some embodiments of the present disclosure;

FIG. 10B is a schematic diagram of a user accepting a content suggestion according to some embodiments of the present disclosure;

FIG. 11A is a schematic diagram of obtaining improvement suggestions by chatting with an agent according to some embodiments of the present disclosure;

FIG. 11B is a schematic diagram of obtaining improvement suggestions by chatting with an agent according to some other embodiments of the present disclosure;

FIG. 12 is a block diagram of an interaction apparatus according to some embodiments of the present disclosure;

FIG. 13 is a block diagram of an interaction apparatus according to some other embodiments of the present disclosure;

FIG. 14 is a block diagram of an electronic device according to some embodiments of the present disclosure.

It should be understood that, for ease of description, the dimensions of the various parts shown in the drawings are not necessarily drawn to scale. Throughout the drawings, the same or similar reference numbers refer to the same or similar components. Therefore, once an item is defined in one drawing, it may not be further discussed in subsequent drawings.

### DETAILED DESCRIPTION OF EMBODIMENTS

The technical solutions in the embodiments of the present disclosure will be described clearly and completely with reference to the drawings in the embodiments of the present disclosure. It should be understood that the present disclosure may be implemented in various forms and should not be construed as limited to the embodiments set forth herein.

It should be understood that the various steps described in the method implementations of the present disclosure may be performed in different orders and/or in parallel. Furthermore, the method implementations may include additional steps and/or omit performing the illustrated steps. The scope of the present disclosure is not limited in this regard. Unless otherwise specifically stated, the relative arrangements, numerical expressions and values of the components and steps set forth in these embodiments should be construed as merely exemplary and not limiting the scope of the present disclosure.

The term "include/comprise" and its variants used in the present disclosure are open terms that mean "include/comprise at least the following element/feature, but not exclude other elements/features", that is, "include/comprise but not limited to". The term "based on" means "at least partially based on".

It should be noted that the concepts such as "first" and "second" mentioned in the present disclosure are only used to distinguish different apparatuses, modules or units, and are not used to limit the order or interdependence of the functions performed by these apparatuses, modules or units. Unless otherwise specified, concepts such as "first" and "second" are not intended to imply that the objects so described must be in a given order in terms of time, space, ranking, or any other way.

It should be noted that the modifiers of "one" and "a plurality of" mentioned in the present disclosure are illustrative and not restrictive, and those skilled in the art should understand that unless clearly indicated in the context, they should be understood as "one or more".

The names of messages or information exchanged between a plurality of apparatuses in the implementations of the present disclosure are only for illustrative purposes, and are not used to limit the scope of these messages or information.

The user information (including but not limited to user device information, user personal information, etc.) and data (including but not limited to data for analysis, stored data, displayed data, etc.) involved in the present disclosure are all information and data authorized by the user or fully authorized by all parties, and the collection, use and processing of relevant data need to comply with relevant laws, regulations and standards of relevant countries and regions, and provide corresponding operation entrance for users to choose authorization or rejection.

The embodiments of the present disclosure will be described in detail below with reference to the drawings, but the present disclosure is not limited to these specific embodiments. The following specific embodiments may be combined with each other, and the same or similar concepts or processes may not be repeated in some embodiments. In addition, in one or more embodiments, the specific features, structures or characteristics may be combined in any suitable way that will be clear to those of ordinary skill in the art from this disclosure.

In the related art, information replied by an agent is presented on a conversation interface in the form of conversation, and a user cannot edit the information replied by the agent. The present disclosure provides an interaction method, which is applicable to editing multi-genre information in a composite scenario of conversation and editing, to help users quickly complete creation and improve the experience of the users in using the agent.

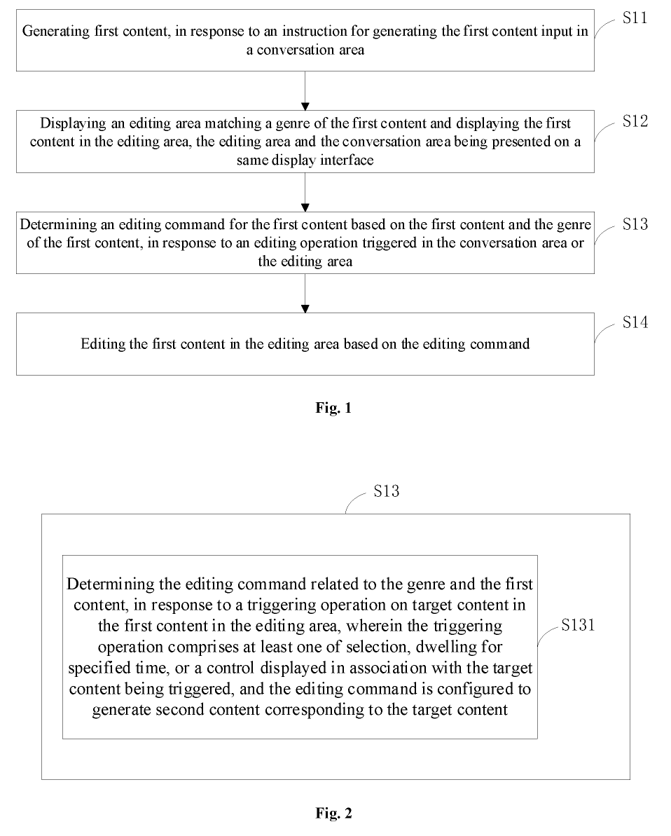

FIG. 1 is a schematic flowchart of an interaction method according to some embodiments of the present disclosure.

As shown in FIG. 1, the interaction method includes: step S11, generating first content, in response to an instruction for generating the first content input in a conversation area; step S12, displaying an editing area matching a genre of the first content and displaying the first content in the editing area, the editing area and the conversation area being presented on a same interface; step S13, determining an editing command for the first content based on the first content and the genre of the first content, in response to an editing operation triggered in the conversation area or the editing area; and step S14, editing the first content in the editing area based on the editing command.

When creating content, for example, in order to conceive an article more flexibly, the user may choose to create a new blank document. In the conversation area, the agent may provide some writing guidance for the user, for example, by telling the agent his/her identity and writing requirements, to the user may further discuss a topic selection, or the user may also directly input a writing theme. The user may also directly write document content in the editing area, or use AI (Artificial Intelligence) to assist with writing, write an outline first, import a document, or select a template to add content.

The interface of the agent includes a conversation area and an editing area. In some embodiments, the conversation area is displayed first on the interface, and then the editing area is displayed, and finally the conversation area and the editing area are presented on the interface at the same time. In some other embodiments, the conversation area and the editing area are displayed on the interface at the same time.

The genre of the first content may also be referred to as a type, for example, the genre includes writing, programming, image or reading, etc. Accordingly, the editing area supports multi-genre editing, for example, the editing area may be a text editing area, a code editing area, an image editing area, a reader area, etc. This embodiment may implement linkage with the editing area based on the conversation in the conversation area. For example, the user interacts with the agent, and the agent may recognize the genre of the first content indicated by the user, and then call the editing area corresponding to the genre, and the editing area may also be referred to as an editing page. The editing area may be an editing page that may be freely edited, and the user may freely modify the content of the editing area, and the editing result will be automatically saved to the latest version.

The user may trigger an editing operation in the conversation area or the editing area, and the agent determines an editing command for the first content based on specific information and the genre of the first content, and the editing command may also be referred to as an editing tool. The editing command is, for example, various commands such as a continuation command, a writing assistance command, an erasing command, a batch processing command, a programming command, and a translation command. For different genres and specific content, the agent may provide different editing commands. The editing commands are configured to edit, modify, or optimize the first content, so as to help the user improve the content through the agent.

In this embodiment, the conversation area and the editing area are displayed on the same interface, and the editing area matches the genre of the generated content, which is convenient for editing the generated content. Since the editing command is determined based on the generated content and the genre of the generated content, the agent may perform targeted editing on the generated content of any genre, which may improve the creation efficiency of the user, thereby improving the user experience.

An interaction method based on different editing modes will be introduced below with reference to FIGS. 2-11B.

FIG. 2 is a schematic flowchart of determining an editing command for first content according to some embodiments of the present disclosure.

As shown in FIG. 2, step S13 includes step S131, determining an editing command related to the genre and the first content, in response to a triggering operation on target content in the first content in the editing area, wherein the triggering operation comprises at least one of selection, dwelling for specified time, or a control displayed in association with the target content being triggered, and the editing command is configured to generate second content corresponding to the target content.

For example, the first content is displayed in the editing area, and the user selects an area for the target content in the first content, or hovers an operating component such as a mouse on the target content for 3s (seconds), or clicks or double-clicks a cursor associated with the target content, etc., to implement triggering on the target content, and then the second content corresponding to the target content is generated, thereby implementing editing on the target content. Those skilled in the art should understand that 3s is only used as an example, and the time may be set according to the actual situation. The target content may be part of the first content, or may be all of the first content.

The editing command is related to the genre of the first content and the first content. For example, if the genre of the first content is writing and the first content is related to a children's story, the agent may provide a continuation command, a writing assistance command, a polishing command, etc. If the genre of the first content is writing and the first content is related to a news report, the agent may provide a word order detection command, a typo detection command, etc. If the genre of the first content is writing and the first content is related to an academic paper, the agent may provide a logic judgment command, a data verification command, a rewriting command, etc. If the genre of the first content is an image and the first content is related to a picture, the agent may provide an image expansion command, an erasing command, etc. If the genre of the first content is an image and the first content is related to a plurality of pictures, the agent may provide a batch image retouching command. The image may include a dynamic image such as a video, and may also include a static image. If the genre of the first content is programming and the first content is related to Python code, the agent may provide a function call command, etc. If the genre of the first content is programming and the first content is related to JavaScript code, the agent may provide an array operation command, etc. Those skilled in the art should understand that the above genres, content, and editing commands are only used as examples, and more genres, content, and editing commands may be set according to the actual situation.

For example, the user interacts with the agent, and the agent recognizes the creation intention of the user, for example, the user inputs a creation requirement in the conversation area: "Help me write an article about ***". The agent recognizes that the writing requirement of the user is related to a timeliness hotspot, so the agent matches the capability of searching materials online and automatic picture matching (searching pictures online, AI images), and quickly generates a first draft, including a title, a paragraph framework and specific content. Certainly, the user may also independently choose whether to upload and search materials on the Internet, and use rich writing tools, etc. The agent calls an editor related to writing, and the article is displayed in the editing area. If the cursor of the user hovers on a certain paragraph for 3 seconds or the user clicks the cursor in the certain paragraph, the user does not need to input a command, and the agent recognizes that the user wants to continue writing the certain paragraph of text, and then generates a continuation command to implement continuation of the content of the paragraph of text, thereby improving the writing efficiency of the user.

After generating the second content corresponding to the target content, the agent may implement optimization of the first content. For example, outputting the second content; replacing the target content with the second content and/or adding the second content to an area related to the target content, in response to a confirmation operation on the second content.

For example, the second content is displayed in the editing area in the form of a floating window or the like, and if the generated second content meets the expectation of the user, the user may confirm the second content, and the agent replaces the target content with the second content or inserts the newly generated second content on the basis of the first content. In some embodiments, the target content originally selected by the user is replaced with the newly generated second content, thereby implementing editing on the first content. In some other embodiments, for example, if the target content needs to be continued, the second content may be added below the target content, thereby implementing optimization of the first content.

In some embodiments of the present disclosure, determining the editing command related to the genre and the first content, in response to the triggering operation on the target content in the first content in the editing area includes: recommending a plurality of candidate commands related to the genre and the first content for selection, in response to the triggering operation by the user on the target content in the first content in the editing area; taking a command selected by the user from the plurality of candidate commands as the editing command related to the genre and the first content.

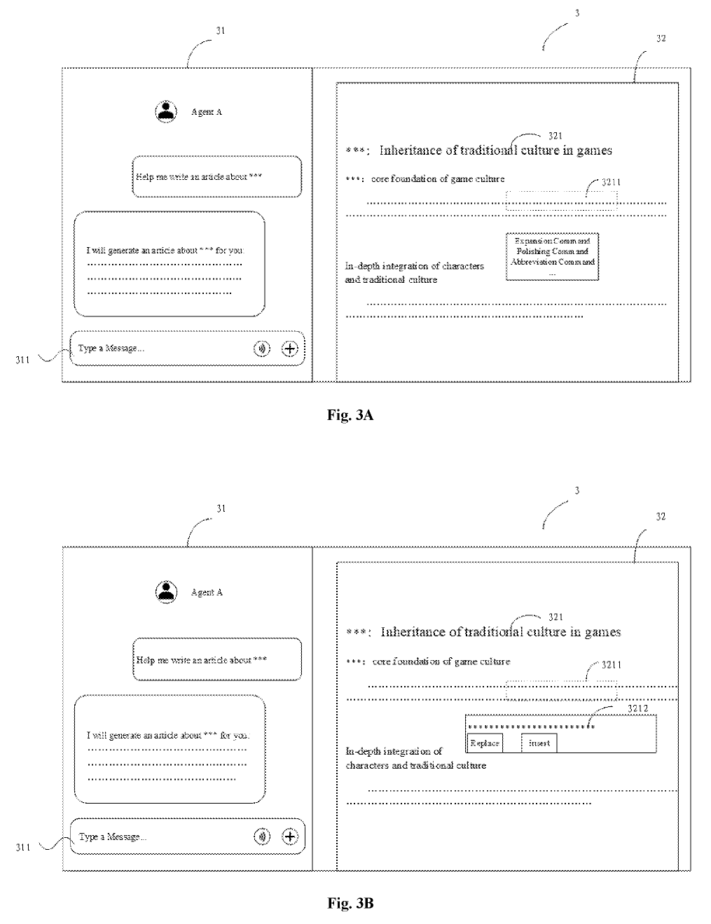

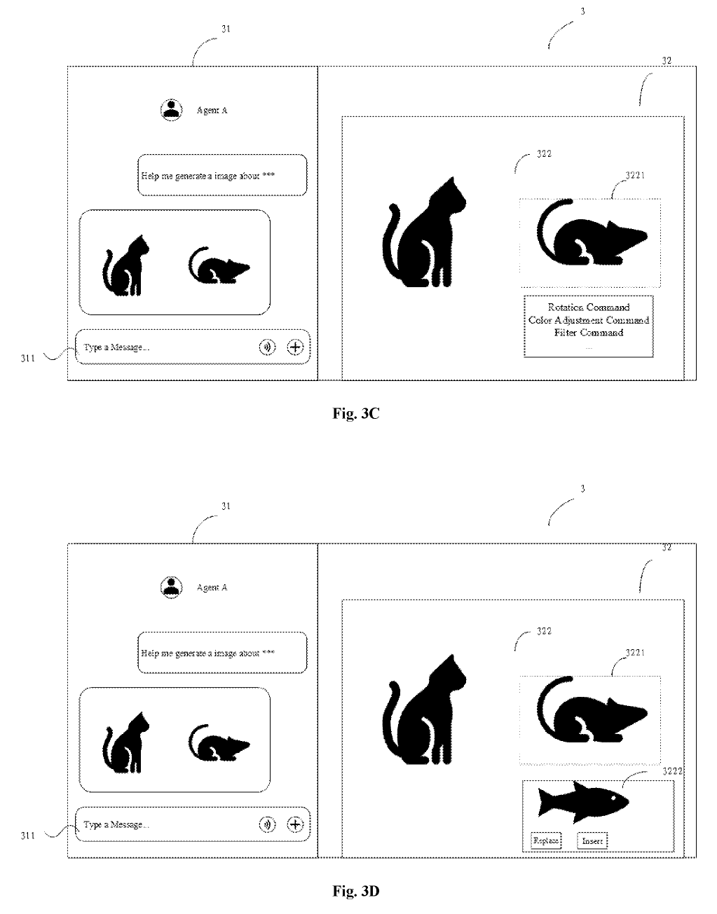

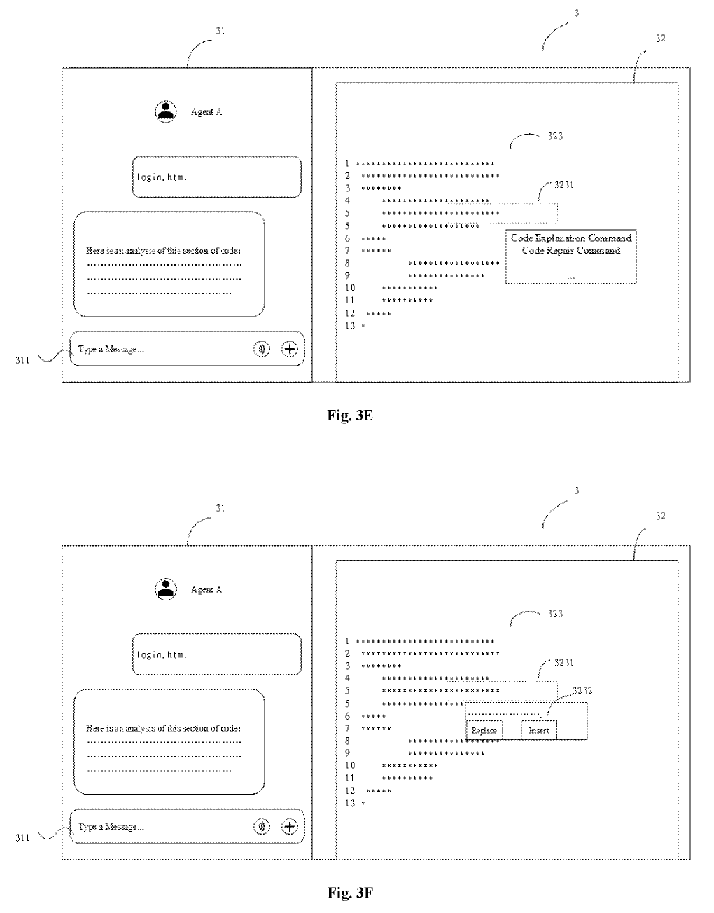

The above embodiments will be introduced below as an example in conjunction with FIGS. 3A-3F.

FIG. 3A is a schematic diagram of an interface related to a writing genre according to some embodiments of the present disclosure. As shown in FIG. 3A, FIG. 3A is an example for the writing genre, and the interface 3 includes a conversation area 31 and an editing area 32, the user may input information in a conversation control 311 in the conversation area 31, generated text content 321 may be displayed in the editing area 32, and the user selects part of content 3211 in the text content 321. A plurality of candidate commands are displayed in the editing area 32, for example, including a polishing command, an expansion command, an abbreviation command, a tone adjustment command, etc., and the tone adjustment command may further include commands such as being more professional, more lively, more straightforward, more confident, and more friendly.

The user selects one command from the candidate commands as the editing command, and edits the part of the content 3211 through the editing command. As shown in FIG. 3B, FIG. 3B is a schematic diagram of an interface related to a writing genre according to some other embodiments of the present disclosure. Related content 3212 corresponding to the part of the content 3211 is output in the form of a floating window. The user may click a replace control or an insert control to implement updating of the part of the content 3211 based on the related content 3212, thereby completing editing of the text content 321.

FIG. 3C is a schematic diagram of an interface related to an image genre according to some embodiments of the present disclosure. As shown in FIG. 3C, FIG. 3C is an example for the image genre, and the interface 3 includes the conversation area 31 and the editing area 32, the user may input information in the conversation control 311 in the conversation area 31, generated image content 322 may be displayed in the editing area 32, and the user selects part of an image 3221 in the image content 322. A plurality of candidate commands are displayed in the editing area 32, for example, including a rotation command, a color adjustment command, a watermark removal command, a filter command, a channel operation command, and the like.

The user selects one command from the candidate commands as the editing command, and edits the part of the image 3221 through the editing command. As shown in FIG. 3D, FIG. 3D is a schematic diagram of an interface related to an image genre according to some other embodiments of the present disclosure. A related image 3222 corresponding to the part of the image 3221 is displayed. The user may click the replace control or the insert control to implement updating of the part of the image 3221 based on the related image 3222, thereby completing editing of the image content 322.

FIG. 3E is a schematic diagram of an interface related to a programming genre according to some embodiments of the present disclosure. As shown in FIG. 3E, FIG. 3E is an example for the programming genre, and the interface 3 includes the conversation area 31 and the editing area 32, the user may input a command in the conversation control 311 in the conversation area 31, generated code content 323 may be displayed in the editing area 32, and the user selects part of code 3231 in the code content 323. A plurality of candidate commands are displayed in the editing area 32, for example, including commands such as code explanation and code repair.

The user selects one command from the candidate commands as the editing command, and edits part of a program 3231 through the editing command. As shown in FIG. 3F, FIG. 3F is a schematic diagram of an interface related to a programming genre according to some other embodiments of the present disclosure. If the user selects the code repair command, related code 3232 corresponding to the part of the code 3231 is displayed in the editing area 32. The user clicks the related code 3232, and the part of the code 3231 is replaced with the related code 3232, thereby implementing optimization of the code content 323.

In some embodiments of the present disclosure, determining the editing command related to the genre and the first content, in response to the triggering operation on the target content in the first content in the editing area includes: displaying a first conversation control related to the target content, in response to the triggering operation triggered on the target content in the first content in the editing area; determining the editing command related to the genre and the first content, in response to first information input in the first conversation control, the editing command is being configured to generate the second content corresponding to the target content based on the first information.

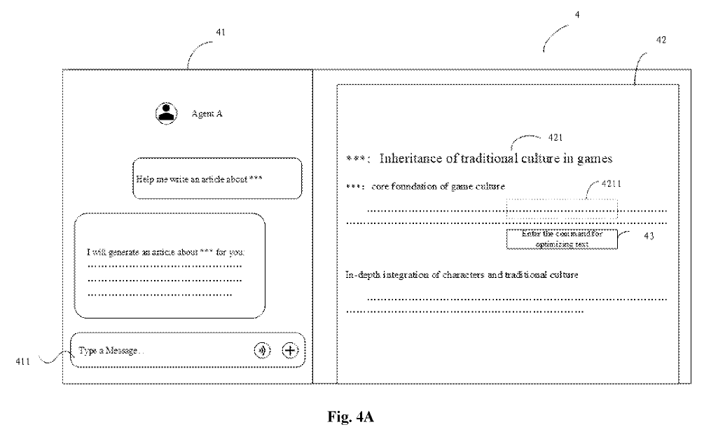

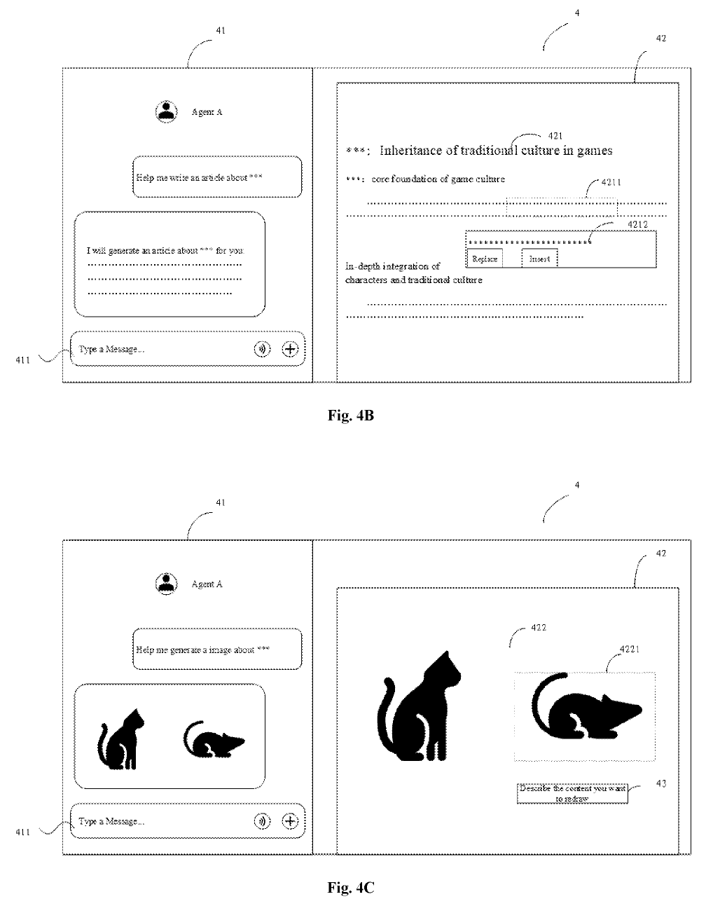

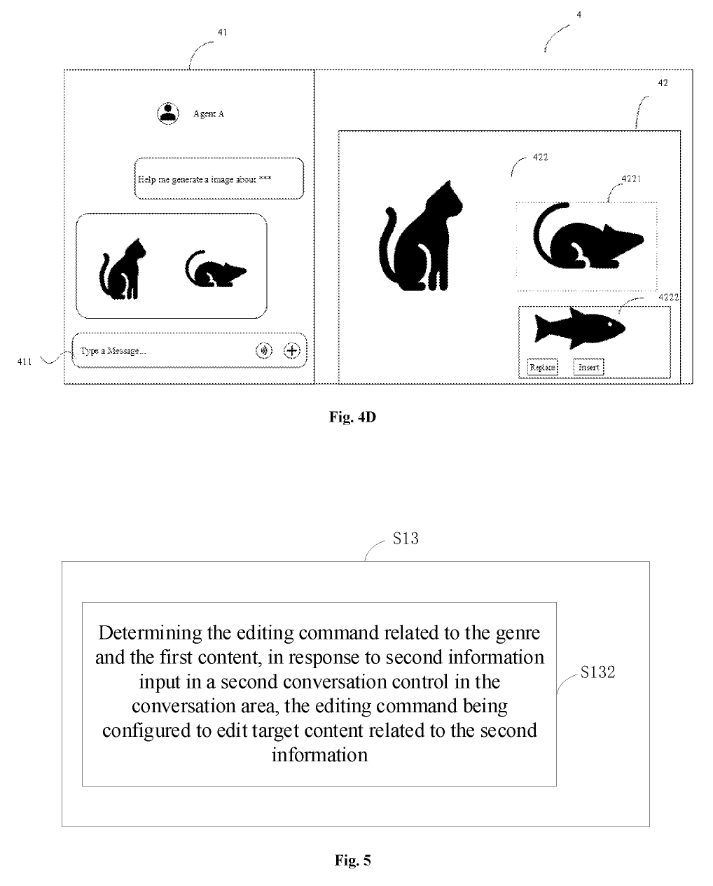

The above embodiments will be introduced below as an example in conjunction with FIGS. 4A-4D.

FIG. 4A is a schematic diagram of an interface related to a writing genre according to still some embodiments of the present disclosure. As shown in FIG. 4A, the interface 4 includes a conversation area 41 and an editing area 42, the user may input information in a conversation control 411 in the conversation area 41, generated text content 421 may be displayed in the editing area 42, the user selects part of content 4211 in the text content 421, and a first conversation control 43 related to the part of the content 4211 is displayed. The user inputs first information in the first conversation control 43, for example, “please help me rewrite this paragraph”. The agent automatically generates a rewriting command, and generates related content 4212 corresponding to the part of the content 4211 based on the rewriting command. As shown in FIG. 4B, similar to FIG. 3B, the agent may output the related content 4212 corresponding to the part of the content 4211 in the form of a floating window. The user may click a replace control or an insert control to implement updating of the part of the content 4211 based on the related content 4212, thereby completing editing of the text content 421.

FIG. 4C is a schematic diagram of an interface related to an image genre according to still some embodiments of the present disclosure. As shown in FIG. 4C, the interface 4 includes the conversation area 41 and the editing area 42, the user may input information in the conversation control 411 in the conversation area 41, generated image content 422 may be displayed in the editing area 42, and the user selects part of an image 4221 in the image content 422,and the first conversation control 43 related to the part of the image 4221 is displayed in the editing area 42. The user inputs the first information in the first conversation control 43, for example, “please help me modify the mouse to a fish”. The agent automatically generates an image retouching command, and generates a related image 4222 corresponding to the part of the image 4221 based on the image retouching command. FIG. 4D is similar to FIG. 3D, and the related image 4222 corresponding to the part of the image 4221 is displayed in the editing area 42. The user may click the replace control to implement updating of the part of the image 4221 based on the related image 4222, thereby completing editing of the image content 422.

FIG. 5 is a schematic flowchart of determining an editing command for first content according to some other embodiments of the present disclosure.

As shown in FIG. 5, step S13 includes step S132, determining an editing command related to the genre and the first content, in response to second information input in a second conversation control in the conversation area, the editing command is configured to edit target content related to the second information.

The target content may be part of the first content, or may be all of the first content. Through the editing command related to the genre and the first content, the target content related to the second information may be edited, thereby helping the user optimize the first content and improve editing efficiency.

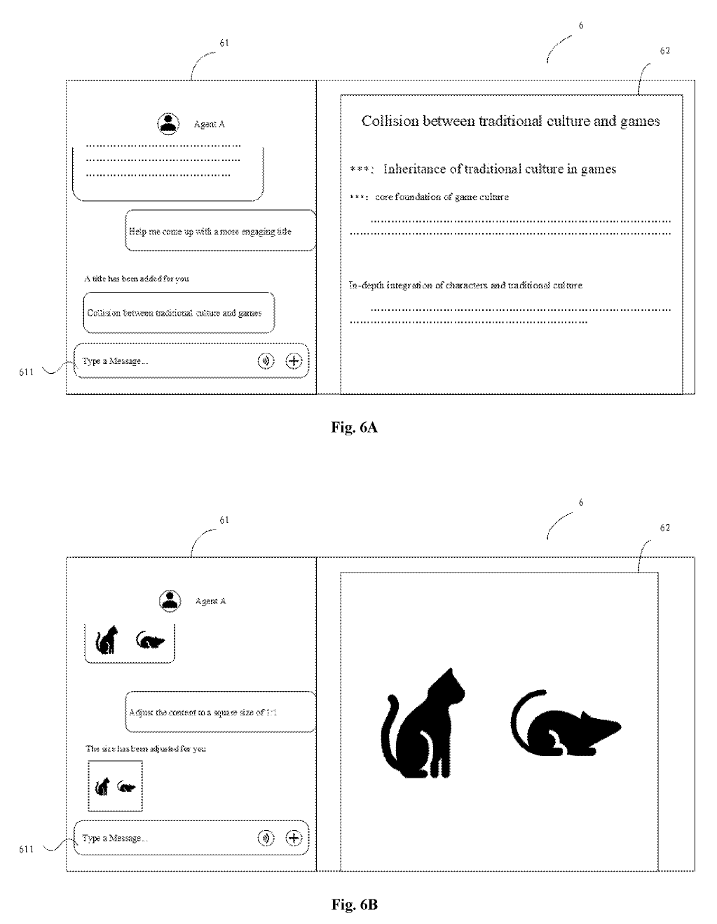

The above embodiments will be introduced below as an example in conjunction with FIGS. 6A-6C.

FIG. 6A is a schematic diagram of an interface related to a writing genre according to yet some embodiments of the present disclosure. As shown in FIG. 6A, FIG. 6A is an example for the writing genre, and the interface 6 includes a conversation area 61 and an editing area 62, the user may input second information in a second conversation control 611 in the conversation area 61, so that the agent edits target content related to the second information in the editing area 62.

For example, the agent helps the user write an article, and the user inputs "Help me come up with/rewrite a more engaging title" in the second conversation control, and the agent generates a title modification command to generate a corresponding title for the article.

For another example, the article contains a plurality of characters "you", and the user inputs "Help me change all instances of "you" to "me" in the second conversation control, and the agent generates a global matching and replacement command to change the characters "you" in the article to character "I".

For another example, the user inputs "Help me add more ** details" in the second conversation control, then the agent generates a command to add details and rewrite accordingly, so as to add ** details to the article.

For another example, the user inputs "Help me translate the whole article into English" in the second conversation control, then the agent generates a translation command to complete translation of the whole article.

FIG. 6B is a schematic diagram of an interface related to an image genre according to yet some embodiments of the present disclosure. As shown in FIG. 6B, in the editing area 62, an image with a rectangular size is generated, and the user inputs "adjust the content to a square size of 1:1" in the second conversation control 611, then the agent modifies the image with the rectangular size to an image with a square size in the editing area.

In the above embodiments, editing of the first content is implemented by means of free conversation.

When the user inputs information in the conversation area, the agent needs to implement positioning of the first content. Therefore, in some embodiments, editing the first content in the editing area based on an editing command includes: positioning target content related to the second information in the first content; and editing the target content based on the editing command.

For example, the user inputs "Please continue writing the second paragraph" in the second conversation control, and the agent needs to first locate the position of the second paragraph in the second information in the article, and then the editing command may edit the content of the second paragraph.

In some embodiments, positioning the target content related to the second information in the first content includes: obtaining an image of the editing area; performing visual understanding on the image; and determining the target content in the first content based on a visual understanding result and the second information.

For example, the agent performs screenshot processing on the editing area, and through visual understanding, the content in the image may be determined, thereby parsing out the target content corresponding to the second information. Furthermore, the target content related to the second information is edited based on the editing command, thereby implementing optimization of the first content.

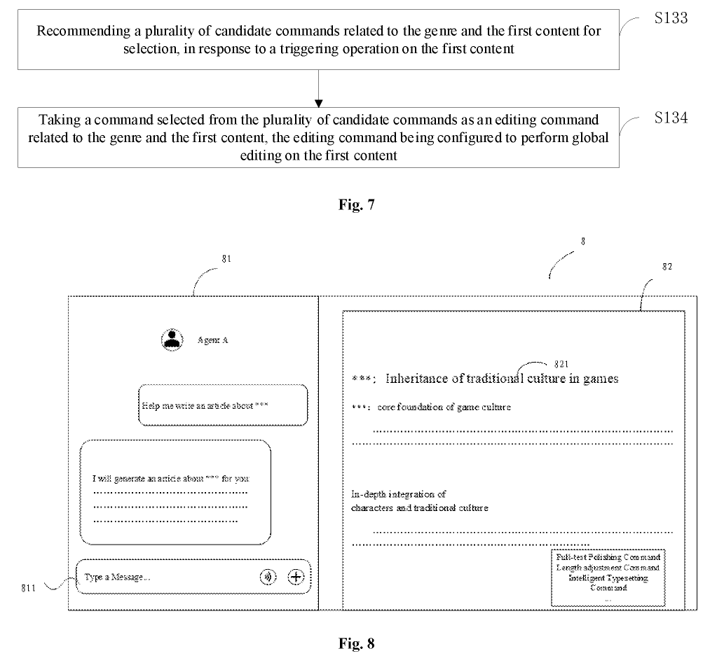

FIG. 7 is a schematic flowchart of determining an editing command for first content according to yet some embodiments of the present disclosure.

As shown in FIG. 7, step S13 includes step S133 and step S134, in step S133, recommending a plurality of candidate commands related to the genre and the first content for selection, in response to a triggering operation on the first content; ; in step S134, taking a command selected from the plurality of candidate commands as an editing command related to the genre and the first content, the editing command being configured to perform global editing on the first content.

For example, the user moves the cursor to the editing area, and the plurality of candidate commands related to the genre and the first content are displayed in the editing area for the user to select. The plurality of candidate commands may be pre-packaged global quick processing commands to help the user quickly complete global editing.

For example, as shown in FIG. 8, FIG. 8 is a schematic diagram of an interface related to a writing genre according to yet some embodiments of the present disclosure. FIG. 8 is an example for the writing genre, and the interface 8 includes a conversation area 81 and an editing area 82, the user may input information in a conversation control 811 in the conversation area 81, generated text content 821 may be displayed in the editing area 82, and a plurality of candidate commands 822 are, for example, a full text polishing command, a length adjustment command, an intelligent typesetting command, a reading level command, a one-click picture matching command, an editing and rewriting command, a generation reference command, etc. For creative articles, the full text polishing command is used to improve literary talent and rhetoric. For efficiency articles, the full text polishing command is used to improve article professionalism. The length adjustment command may further include an expansion command and an abbreviation command. The intelligent typesetting command may optimize typesetting for different genre content in one step. The reading level command may further include an elementary school reading level command, a junior high school reading level command, a senior high school reading level command, or a college reading level command, etc. The generation reference command is used to provide real reference source information for the content, especially data results. The user selects one command from the plurality of candidate commands for editing, thereby enabling global editing of the first content.

For another example, the plurality of candidate commands may also be located in the conversation area. The user selects one command from the plurality of candidate commands in the conversation area for editing, thereby enabling global editing of the first content.

In the above embodiments, global editing of the generated content may be implemented through the global command.

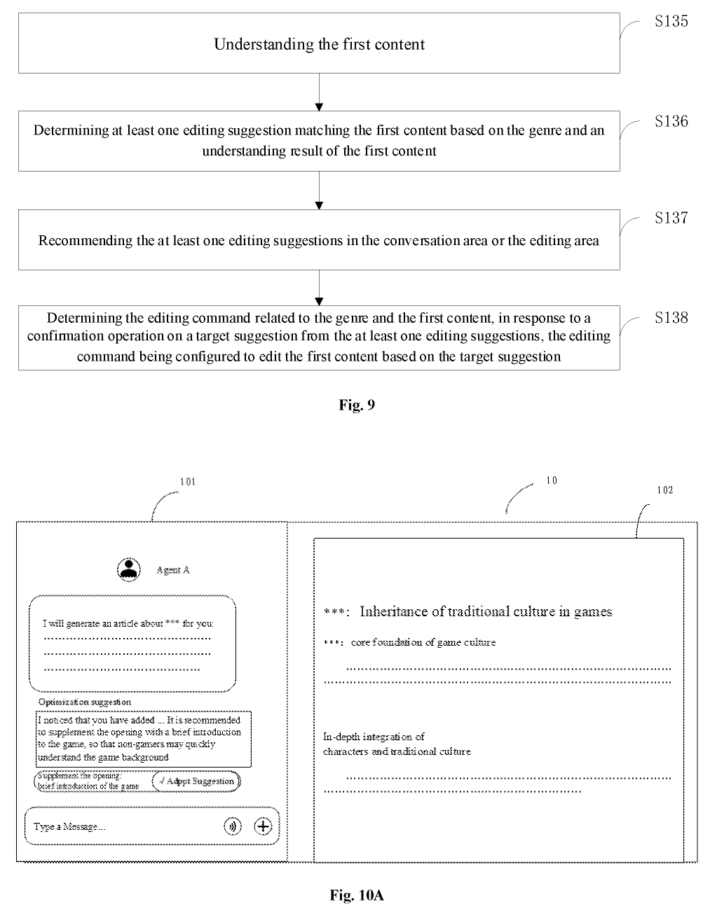

FIG. 9 is a schematic flowchart of determining an editing command for first content according to yet some embodiments of the present disclosure.

As shown in FIG. 9, step S13 includes steps S135 to S138. In step S135, understanding the first content; in step S136, determining at least one editing suggestion matching the first content based on the genre and an understanding result of the first content; in step S137, recommending the at least one editing suggestion in the conversation area or the editing area; in step S138, determining the editing command related to the genre and the first content, in response to a confirmation operation on target suggestion from the at least one editing suggestion, the editing command is configured to edit the first content based on the target suggestion.

For example, the agent understands the first content, determines specific information and the genre in the first content, and then actively gives some creation suggestions, which may be displayed in the conversation area or the editing area. After the user selects a creation suggestion, the agent generates an editing command to edit the first content based on the creation suggestion.

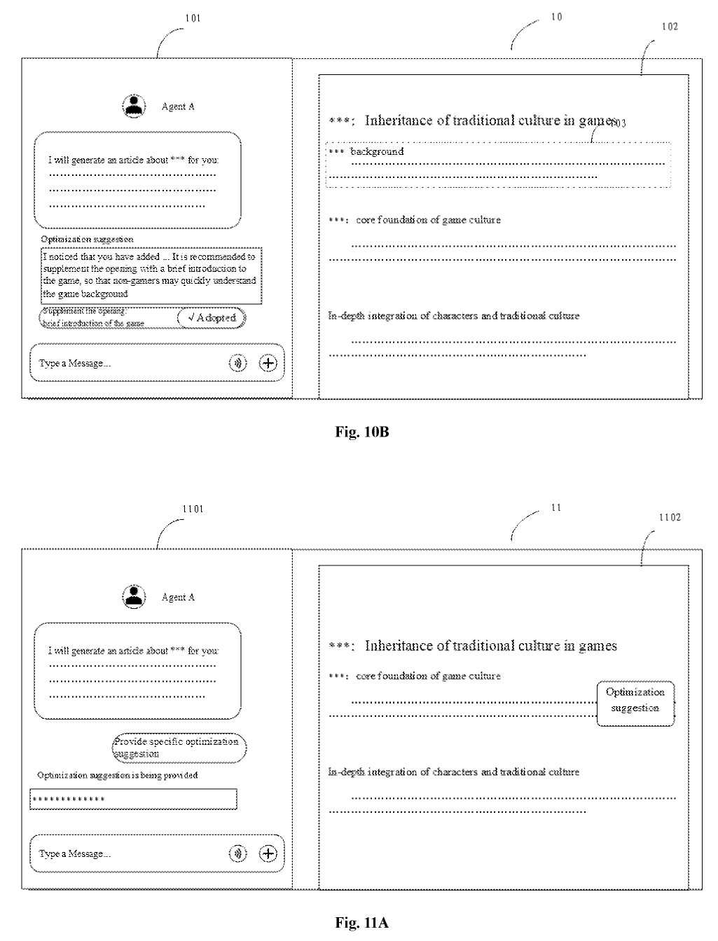

The above embodiments will be introduced below as an example in conjunction with FIGS. 10A and 10B.

FIG. 10A is a schematic diagram of actively providing content suggestions according to some embodiments of the present disclosure, and FIG. 10B is a schematic diagram of a user accepting a content suggestion according to some embodiments of the present disclosure. In this embodiment, after understanding the text content, the agent gives an optimization suggestion in a conversation area 101, for example, supplementing the opening with a brief introduction to the game, so that non-gamers may quickly understand the game background. If the user clicks a control to accept the suggestion, an editing command is generated, and corresponding content 103 is generated in an editing area 102 based on the editing command.

In the above embodiments, the agent actively provides creation suggestions during the creation process, and implements editing of the generated content based on the target suggestion through the editing command, thereby improving optimization efficiency of the generated content.

In some embodiments, the understanding the first content includes: understanding the first content, in response to the agent being instructed in the conversation area to give editing suggestion.

For example, the user inputs a command of "please provide optimization suggestions" in the conversation area, then the agent understands the first content, determines the specific information and the genre in the first content, and then actively gives some creation suggestions, which may be displayed in the conversation area or the editing area. After the user selects a creation suggestion, an editing command is generated to edit the first content based on the creation suggestion.

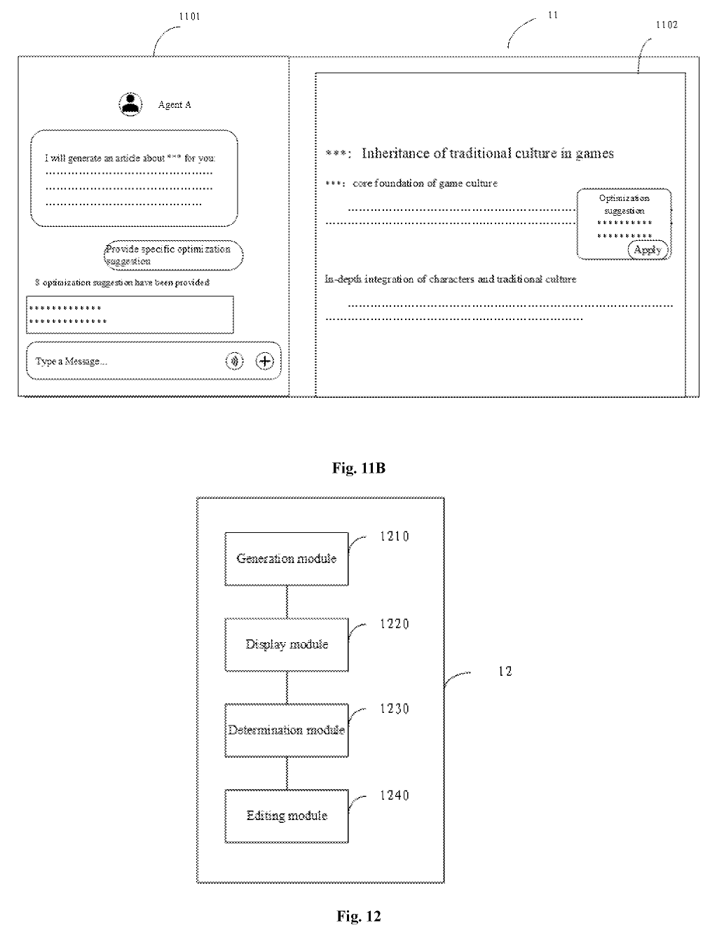

The above embodiments will be introduced below as an example in conjunction with FIGS. 11A and 11B.

FIG. 11A is a schematic diagram of obtaining improvement suggestions by chatting with an agent according to some embodiments of the present disclosure, and FIG. 11B is a schematic diagram of obtaining improvement suggestions by chatting with an agent according to some other embodiments of the present disclosure. The user inputs information of "Provide specific optimization suggestions" in a conversation area 1101. The agent gives some optimization suggestions in an editing area 1102. If the user adopts the optimization suggestions, the agent edits the content in the editing area 1102 through the editing command to quickly improve the quality of the article.

In the above embodiments, the user chats with the agent to obtain improvement suggestions provided by the agent, and then edits the generated content, thereby improving editing efficiency and editing quality.

In some embodiments, a conversation sent by the agent is displayed in the conversation area, and the sent conversation includes the at least one editing suggestion.

For example, as shown in FIG. 10A, the agent displays the editing suggestion in the conversation area by means of conversation, which is convenient for the user to determine whether to adopt the advice in time.

In some other embodiments, a comment is displayed in the editing area, and the comment includes the at least one editing suggestion.

For example, as shown in FIG. 11A, the agent comments in the form of comments, thereby supporting the user to quickly apply optimization suggestions.

In some embodiments of the present disclosure, an editing area matching the genre of the first content is switched to an editing area matching a genre of third content, in response to an instruction for generating the third content input in the conversation area, where the genre of the first content is different from the genre of the third content.

For example, the genre of the first content is writing, the genre of the third content is programming, and the editing area matching the genre of the first content is a text editing area. When generating the third content, the agent calls a program editing area and displays the third content in the program editing area. Thus, linkage between editing areas of a plurality of genres is realized.

For another example, the user first inputs image information in the conversation area, and the agent calls an image editing area to edit image content in the image editing area. Subsequently, the user inputs article creation information in the conversation area, and the agent calls a text editing area to edit the created article in the text editing area.

In some other embodiments of the present disclosure, fourth content is displayed in an editing area matching a genre of the fourth content; the editing area matching the genre of the fourth content is switched to the editing area matching the genre of the first content, in response to the instruction for generating the first content input in the conversation area.

For example, the agent acquires an interaction intention with the user, and if the user wants to read text, a reading editor is called. Then, if the user wants to create on the basis of reading the article, the agent calls a text editor to switch the reading editor to the text editor, thereby implementing linkage between editors of a plurality of genres.

Through the introduction of the above embodiments, the agent may freely switch editors of a plurality of genres based on the user intention. For example, for various scenarios such as reading first and then writing, generating an image first and then writing, writing first and then generating an image, etc., calling an editor matching the generated content is convenient to improve the creation efficiency of the user.

In some other embodiments of the present disclosure, one or more folders are displayed, and the folder(s) are used to store edited content corresponding to the first content.

For example, after completing creation, the user stores the created content into a folder, and the folder is, for example, a cloud disk folder, which is convenient for the user to retrieve and integrate relevant materials subsequently.

In some other embodiments of the present disclosure, a sharing link of the edited content corresponding to the first content is generated to facilitate co-editing.

For example, after completing creation, the user shares the created content with team members and invites them to co-edit online. During the collaboration process, the team may discuss details through the conversation area while directly editing the created content. This embodiment may implement creation sharing and multi-user online editing.

In addition, the user may also export the created content in a predetermined format and send the created content to other users.

The above is the interaction method provided by the embodiments of the present disclosure. An interaction apparatus according to embodiments of the present disclosure will be described below with reference to FIGS. 12-14, which is configured to perform any of the above interaction methods.

FIG. 12 is a block diagram of an interaction apparatus according to some embodiments of the present disclosure.

As shown in FIG. 12, the interaction apparatus 12 includes a generation module 1210, a display module 1220, a determination module 1230, and an editing module 1240.

The generation module 1210 is configured to generate first content, in response to an instruction for generating the first content input in a conversation area; the display module 1220 is configured to display an editing area matching a genre of the first content and to display the first content in the editing area, the editing area and the conversation area being presented on a same interface; the determination module 1230 is configured to determine an editing command for the first content based on the first content and the genre of the first content, in response to an editing operation triggered in the conversation area or the editing area; and the editing module 1240 is configured to edit the first content in the editing area based on the editing command.

In some embodiments, the determination module 1230 is configured to determine an editing command related to the genre and the first content, in response to a triggering operation on target content in the first content in the editing area, wherein the triggering operation comprises at least one of selection, dwelling for specified time, or a control displayed in association with the target content being triggered, and the editing command is configured to generate second content corresponding to the target content.

In some embodiments, the determination module 1230 is configured to recommend a plurality of candidate commands related to the genre and the first content for selection, in response to the triggering operation on the target content in the first content in the editing area; and take a command selected from the plurality of candidate commands as the editing command related to the genre and the first content.

In some embodiments, the determination module 1230 is configured to display a first conversation control related to the target content, in response to the triggering operation on the target content in the first content in the editing area; and determine the editing command related to the genre and the first content, in response to first information input in the first conversation control, the editing command being configured to generate the second content corresponding to the target content based on the first information.

In some embodiments, the editing module 1240 is configured to output the second content; perform at least one of replacing the target content with the second content or adding the second content to an area related to the target content, in response to a confirmation operation on the second content.

In some embodiments, the determination module 1230 is configured to determine an editing command related to the genre and the first content, in response to second information input in a second conversation control in the conversation area, and the editing command is configured to edit target content related to the second information.

In some embodiments, the editing module 1240 is configured to locate target content related to the second information in the first content; and edit the target content based on the editing command.

In some embodiments, the editing module 1240 is configured to acquire an image of the editing area; perform visual understanding on the image; and determine the target content in the first content based on a visual understanding result and the second information.

In some embodiments, the determination module 1230 is configured to recommend a plurality of candidate commands related to the genre and the first content for selection, in response to a triggering operation on the first content; and take a command selected from the plurality of candidate commands as an editing command related to the genre and the first content, the editing command being configured to perform global editing on the first content.

In some embodiments, the determination module 1230 is configured to understand the first content; determine at least one editing suggestion matching the first content based on the genre and an understanding result of the first content; recommend the at least one editing suggestion in the conversation area or the editing area; and determine the editing command related to the genre and the first content, in response to a confirmation operation on a target suggestion from the at least one editing suggestions, the editing command being configured to edit the first content based on the target suggestion.

In some embodiments, the determination module 1230 is configured to understand the first content, in response to an agent being instructed to provide the editing suggestions in the conversation area.

In some embodiments, the determination module 1230 is configured to display a conversation sent by the agent in the conversation area, the sent conversation comprising the at least one editing suggestion; and/or display a comment in the editing area, the comment comprising the at least one editing suggestion.

In some embodiments, the interaction apparatus further includes a switching module (not shown) configured to switch the editing area matching the genre of the first content to an editing area matching a genre of third content, in response to an instruction for generating the third content input in the conversation area, where the genre of the first content is different from the genre of the third content.

In some embodiments, the display module is further configured to display fourth content in an editing area matching a genre of the fourth content; the switching module is configured to switch the editing area matching the genre of the fourth content to the editing area matching the genre of the first content, in response to the instruction for generating the first content input in the conversation area.

In some embodiments, the display module is further configured to display one or more folders, the folder(s) being used to store edited content corresponding to the first content.

In some embodiments, the generation module is further configured to generate a sharing link of the edited content corresponding to the first content to facilitate co-editing.

In the above embodiments, the conversation area and the editing area are displayed on the same interface, and the editing area matches the genre of the generated content, which is convenient for editing the generated content. Since the editing command is determined based on the generated content and the genre of the generated content, the agent may perform targeted editing on the generated content of any genre, which may improve the creation efficiency of the user, thereby improving the user experience.

It should be noted that the above units are only logical modules divided according to the specific functions they implement, and are not used to limit the specific implementation, for example, it may be implemented in software, hardware, or a combination of software and hardware. In an actual implementation, the above units may be implemented as independent physical entities, or may be implemented by a single entity (for example, a processor (CPU or DSP, etc.), an integrated circuit, etc.). In addition, the above units are indicated by dotted lines in the drawings to indicate that these units may not actually exist, and the operations/functions implemented by them may be implemented by the processing circuit itself.

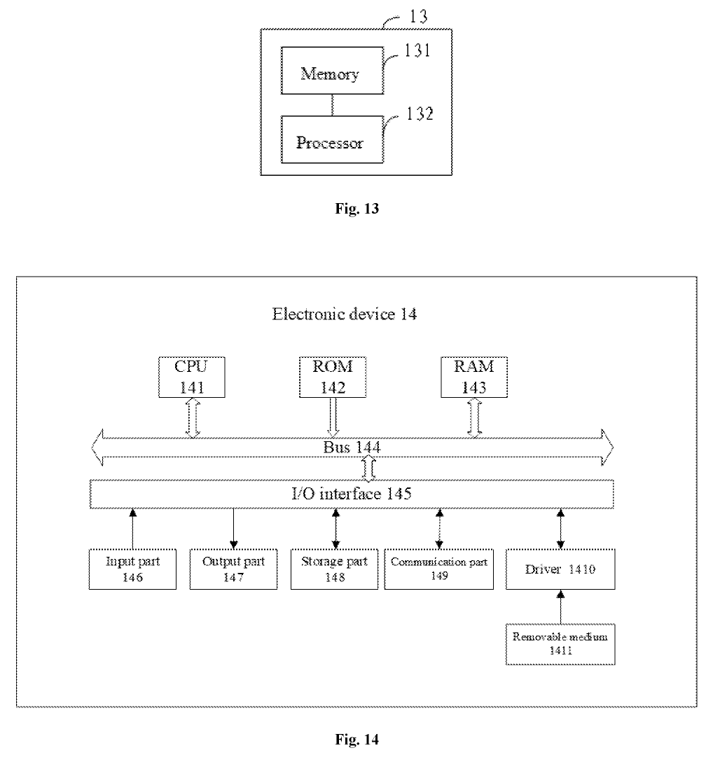

FIG. 13 is a block diagram of an interaction apparatus according to some other embodiments of the present disclosure.

As shown in FIG. 13, the interaction apparatus includes a memory 131; and a processor 132 coupled to the memory, the processor being configured to carry out the interaction method as described above based on instructions stored in the memory.

The memory 131 is used to store one or more computer-readable instructions. The memory 131 may include any combination of various forms of computer-readable storage media, such as volatile memory and/or non-volatile memory, including but not limited to random access memory (RAM), dynamic random access memory (DRAM), static random access memory (SRAM), read only memory (ROM), and flash memory. The memory 131 may store, for example, an operating system, an application program, a boot loader, a database, and other programs, and may also store various application programs, various data, and the like.

The processor 132 is used to run the computer-readable instructions to implement the interaction method of any one of the above embodiments or the interaction method of any one of the above embodiments. For the specific implementation of each step of the method, reference may be made to the above embodiments, and the repeated parts will not be repeated here.

The processor 132 may be configured to execute the steps in FIGS. 1-11B. The processor 132 may be embodied as various processing apparatuses, such as a central processing unit (CPU), a network processor (NP), etc.; and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 132 and the memory 131 may communicate with each other directly or indirectly. For example, the processor 132 and the memory 131 may communicate through a network. The network may include a wireless network, a wired network, and/or any combination of a wireless network and a wired network. The processor 132 and the memory 131 may also communicate with each other through a system bus, which is not limited in the present disclosure.

It should be noted that the components of the interaction apparatus 13 shown in FIG. 13 are only exemplary and non-restrictive. According to actual application requirements, the interaction apparatus 13 may also have other components. The processor 132 may control other components in the electronic device 13 to perform desired functions.

In the above embodiments, the data instruction is stored in the memory, and the instruction is then processed by the processor, so that the generated content of any genre may be edited in a targeted manner, which may improve the creation efficiency of the user, thereby improving the user experience.

The interaction apparatus 13 may be implemented by software, firmware, and/or hardware, and may be integrated in an apparatus installed with relevant applications.

FIG. 14 is a block diagram of an electronic device according to some embodiments of the present disclosure.

The electronic device 14 shown in FIG. 14 may be a computer system having a dedicated hardware structure, and may perform corresponding functions when installed with relevant applications.

The electronic device includes, but is not limited to, mobile terminals such as a smart phone, a laptop, a personal digital assistant (PDA), a tablet personal computer (Tablet PC), a portable multimedia player (PMP), a vehicle-mounted terminal (such as a vehicle navigation terminal), a wearable device, etc., and fixed terminals such as a digital TV, a desktop computer, etc.

As shown in FIG. 14, a central processing unit (CPU) 141 executes various processes according to a program stored in a read-only memory (ROM) 142 or a program loaded from a storage part 148 into a random access memory (RAM) 143. In the RAM 143, data required when the CPU 141 executes various processes and the like is stored as needed. The central processing unit is only exemplary, and it may also be other types of processors, such as various processors as described above. The ROM 142, the RAM 143, and the storage part 148 may be various forms of computer-readable storage media. It should be noted that although the ROM 142, the RAM 143, and the storage part 148 are shown separately in FIG. 14, one or more of them may be combined or located in the same or different memories or storage modules.

The CPU 141, the ROM 142, and the RAM 143 are connected to each other via a bus 144. An input/output interface 145 is also connected to the bus 144.

The following components are connected to the input/output interface 145: an input part 146, such as a touch screen, a touchpad, a keyboard, a mouse, an image sensor, a microphone, an accelerometer, a gyroscope, etc.; an output part 147, including a display, such as a cathode ray tube (CRT), a liquid crystal display (LCD), a speaker, a vibrator, etc.; the storage part 148, including a hard disk, a magnetic tape, etc.; and a communication part 149, including a network interface card, such as a LAN card, a modem, etc. The communication part 149 allows communication processing to be performed via a network such as the Internet. It is easy to understand that although the components in the electronic device 14 shown in FIG. 14 communicate through the bus 144, they may also communicate through a network or other means, where the network may include a wireless network, a wired network, and/or any combination of a wireless network and a wired network.

If required, a driver 1410 is also connected to the input/output interface 145. A removable medium 1411, such as a magnetic disk, an optical disc, a magneto-optical disc, a semiconductor memory, etc., is installed on the driver 1410 as required, so that a computer program read therefrom is installed into the storage part 148 as required.

In the case of implementing the above series of processes by means of software, a program that constitutes the software may be installed from a network such as the Internet or a storage medium such as the removable medium 1411.

According to an aspect of the present disclosure, there is provided a computer-readable storage medium having computer instructions stored thereon, where the interaction method as described above is implemented when the instructions are executed by a processor.

The computer-readable storage medium may improve the creation efficiency of the user.

According to an aspect of the present disclosure, there is provided a computer program product, including: computer instructions, where the interaction method as described above is implemented when the computer instructions are executed by a processor.

The computer program product may improve the creation efficiency of the user and improve the user experience.

According to the embodiments of the present disclosure, the process described above with reference to the flowchart may be implemented as a computer software program. For example, some embodiments of the present disclosure include a computer program product, which, when running on a computer, causes the computer to implement the method of any one of the above embodiments. The computer program product includes computer instructions carried on a computer-readable medium, and includes program code for executing the method shown in the flowchart. In such an embodiment, the computer instructions may be downloaded and installed from a network via the communication part 149, or installed from the storage part 148, or installed from the ROM 142. When the computer program is executed by the CPU 141, the method of the embodiments of the present disclosure is executed.

It should be noted that in the context of the present disclosure, the computer-readable medium may be a tangible medium that may include or store a program for use by or in combination with an instruction execution system, apparatus or device.

The computer-readable medium may be a computer-readable storage medium, a computer-readable signal medium, or any combination of the above, and the computer-readable storage medium is a non-transitory computer storage medium.

The computer-readable storage medium includes, but is not limited to, an electrical, magnetic, optical, electromagnetic, infrared, or semiconductor system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that includes or stores a program, and the program may be used by or in combination with an instruction execution system, apparatus or device. The computer-readable storage medium has computer instructions stored thereon, and the method of any one of the above embodiments is implemented when the instructions are executed by a processor.

The computer-readable signal medium may include a data signal propagated in a baseband or as a part of a carrier wave, and computer-readable program code is carried therein. This propagated data signal may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit a program for use by or in combination with an instruction execution system, apparatus or device. The program code contained on the computer-readable medium may be transmitted by any suitable medium, including but not limited to: a wire, an optical cable, RF (radio frequency), etc., or any suitable combination of the above.

The above computer-readable medium may be included in the above electronic device; or it may exist alone without being assembled into the electronic device.

In some embodiments, there is further provided a computer program, including: instructions, which, when executed by a processor, cause the processor to execute the method of any one of the above embodiments. For example, the instructions may be embodied as computer program code.

In the embodiments of the present disclosure, the computer program code for performing the operations of the present disclosure may be written in one or more programming languages or a combination thereof, the above programming languages including but not limited to object-oriented programming languages, such as Java, Smalltalk, C++, and including conventional procedural programming languages, such as "C" language or similar programming languages. The program code may be executed entirely on a user computer, partly on the user computer, as a stand-alone software package, partly on the user computer and partly on a remote computer, or entirely on the remote computer or server. In the case of involving a remote computer, the remote computer may be connected to the user computer through any kind of network (including a local area network (LAN) or a wide area network (WAN)), or it may be connected to an external computer (for example, connected by using Internet provided by an Internet service provider).

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, which includes one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that executes specified functions or operations, or may be implemented by a combination of dedicated hardware and computer instructions.

The functions described above may be performed at least partially by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logic device (CPLD), etc.

Although some specific embodiments of the present disclosure have been described in detail by way of examples, those skilled in the art should understand that the above examples are only for illustration, rather than limiting the scope of the present disclosure. Those skilled in the art should understand that the above embodiments may be modified without departing from the scope and spirit of the present disclosure. The scope of the present disclosure is defined by the appended claims.

1. An interaction method, comprising:
generating first content, in response to an instruction for generating the first content input in a conversation area;
displaying an editing area matching a genre of the first content and displaying the first content in the editing area, the editing area and the conversation area being presented on a same interface;
determining an editing command for the first content based on the first content and the genre of the first content, in response to an editing operation triggered in the conversation area or the editing area; and
editing the first content in the editing area based on the editing command.

2. The interaction method of claim 1, wherein determining the editing command for the first content based on the first content and the genre of the first content comprises:
determining the editing command related to the genre and the first content, in response to a triggering operation on target content in the first content in the editing area, wherein the triggering operation comprises at least one of selection, dwelling for specified time, or a control displayed in association with the target content being triggered, and the editing command is configured to generate second content corresponding to the target content.

3. The interaction method of claim 2, wherein determining the editing command related to the genre and the first content, in response to the triggering operation on the target content in the first content in the editing area comprises:
recommending a plurality of candidate commands related to the genre and the first content for selection, in response to the triggering operation on the target content in the first content in the editing area;
taking a command selected from the plurality of candidate commands as the editing command related to the genre and the first content.

4. The interaction method of claim 2, wherein determining the editing command related to the genre and the first content, in response to the triggering operation on the target content in the first content in the editing area comprises:
displaying a first conversation control related to the target content, in response to the triggering operation on the target content in the first content in the editing area;
determining the editing command related to the genre and the first content, in response to first information input in the first conversation control, the editing command being configured to generate the second content corresponding to the target content based on the first information.

5. The interaction method of claim 2, wherein editing the first content in the editing area based on the editing command comprises:
outputting the second content;
perform at least one of replacing the target content with the second content or adding the second content to an area related to the target content, in response to a confirmation operation on the second content.

6. The interaction method of claim 1, wherein determining the editing command for the first content based on the first content and the genre of the first content comprises:
determining the editing command related to the genre and the first content, in response to second information input in a second conversation control in the conversation area, the editing command being configured to edit target content related to the second information.

7. The interaction method of claim 6, wherein editing the first content in the editing area based on the editing command comprises:
positioning the target content related to the second information in the first content;
editing the target content based on the editing command.

8. The interaction method of claim 7, wherein positioning the target content related to the second information in the first content comprises:
acquiring an image of the editing area;
performing visual understanding on the image; and
determining the target content in the first content based on a visual understanding result and the second information.

9. The interaction method of claim 1, wherein determining the editing command for the first content based on the first content and the genre of the first content comprises:
recommending a plurality of candidate commands related to the genre and the first content for selection, in response to a triggering operation on the first content;
taking a command selected from the plurality of candidate commands as an editing command related to the genre and the first content, the editing command being configured to perform global editing on the first content.

10. The interaction method of claim 1, wherein determining the editing command for the first content based on the first content and the genre of the first content comprises:
understanding the first content;
determining at least one editing suggestion matching the first content based on the genre and an understanding result of the first content;
recommending the at least one editing suggestion in the conversation area or the editing area;
determining the editing command related to the genre and the first content, in response to a confirmation operation on a target suggestion from the at least one editing suggestions, the editing command being configured to edit the first content based on the target suggestion.

11. The interaction method of claim 10, wherein understanding the first content comprises:
understanding the first content, in response to an agent being instructed to provide the editing suggestions in the conversation area.

12. The interaction method of claim 10, wherein displaying the at least one editing suggestion comprises at least one of following:
displaying a conversation sent by the agent in the conversation area, the sent conversation comprising the at least one editing suggestion; or
displaying a comment in the editing area, the comment comprising the at least one editing suggestion.

13. The interaction method of claim 1, further comprising:
switching the editing area matching the genre of the first content to an editing area matching a genre of third content, in response to an instruction for generating the third content input in the conversation area, wherein the genre of the first content is different from the genre of the third content.

14. The interaction method of claim 1, further comprising:
displaying fourth content in an editing area matching a genre of the fourth content;
switching the editing area matching the genre of the fourth content to the editing area matching the genre of the first content, in response to the instruction for generating the first content input in the conversation area.

15. The interaction method of claim 1, further comprising at least one of following:
displaying one or more folders, the one or more folders being used to store edited content corresponding to the first content; or
generating a sharing link of the edited content corresponding to the first content to facilitate co-editing.

16. An interaction apparatus, comprising:
a memory; and
a processor coupled to the memory, wherein the processor is configured to, based on instructions stored in the memory, implement the interaction method of claim 1.

17. The interaction apparatus of claim 16, wherein determining the editing command for the first content based on the first content and the genre of the first content comprises:
determining the editing command related to the genre and the first content, in response to a triggering operation on target content in the first content in the editing area, wherein the triggering operation comprises at least one of selection, dwelling for specified time, or a control displayed in association with the target content being triggered, and the editing command is configured to generate second content corresponding to the target content.

18. The interaction apparatus of claim 16, wherein determining the editing command for the first content based on the first content and the genre of the first content comprises:
determining the editing command related to the genre and the first content, in response to second information input in a second conversation control in the conversation area, the editing command being configured to edit target content related to the second information.

19. A non-transitory computer-readable storage medium having computer instructions stored thereon, wherein the interaction method of claim 1 is implemented when the instructions are executed by a processor.

20. The non-transitory computer-readable storage medium of claim 19, wherein determining the editing command for the first content based on the first content and the genre of the first content comprises:
recommending a plurality of candidate commands related to the genre and the first content for selection, in response to a triggering operation on the first content;
taking a command selected from the plurality of candidate commands as an editing command related to the genre and the first content, the editing command being configured to perform global editing on the first content.
